(19) United States
(12) Patent Application Publication
(10) Pub. No.: US 2005/0204563 A1
(43) Pub. Date: Sep. 22, 2005

(54) Tool combination assembly

(76) Inventor: Eric Stender, Middlesex, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/804,410

(22) Filed: Mar. 19, 2004

(51) Int. Cl. B26B 1/00

(52) U.S. Cl. 30/123; 30/516

(57) ABSTRACT

Assembly for working on a material. The tool having a forced air portion with an outlet and a hand tool portion with a working end. The forced air portion aimed toward a working end of the hand tool portion.

### BACKGROUND OF THE INVENTION

The present invention relates to a combination tool assembly having a forced air stream portion and a hand tool portion for engaging various material. More specifically, the present invention combines a heating element such as a conventional blow dryer with various hand tools including, but not limited to, shears, drills, saws, caulking guns, and the like.

When using various hand tools, construction workers often find themselves working in cold climate areas. Besides having a negative effect for the construction workers themselves, cold climates may cause the materials they are working with to become brittle. This result increases the complexity of performing many tasks as the brittle material must be carefully handled to prevent inadvertent tears and cracking. Most particularly, the cold affects materials such as siding made from polyvinyl chloride and similar plastic materials, commonly referred to as “vinyl siding” as well as accessory elements for the same.

Although many areas across the globe are only affected by cold conditions for a couple of months per year, there still remain many populated geographic locations where cold seasons may extend far beyond the winter months. Furthermore, even in geographic locations only affected by cold conditions for a short time, the construction workers do not always have the option of using their skills inside rather than outside. Therefore, construction workers and the like often find themselves having to work in cold conditions with material not well suited for the climate they are confronted with.

Most specifically, vinyl siding has a tendency to become brittle during long exposures to the cold. This result is extremely unfortunate when cutting, drilling into or shearing the siding as inadvertent cracks may result. The carpenter or construction worker generally first measures the length needed to be placed against a building or structure. The carpenter then measures out a piece of vinyl siding and marks the siding using a pencil or other implement. The vinyl siding is then cut along the scribed line to achieve the desired length. However, in a situation where the vinyl siding has been exposed to the cold and has become brittle, the carpenter may find that obtaining a straight cut becomes more complicated and difficult to achieve as various tears, rips, and cracks inadvertently may promulgate due to an external force i.e., shears being applied to a brittle material.

Other circumstances where the brittleness of the vinyl siding has unfortunate consequences include where the siding is already placed on the house and a carpenter, repairman or the like wishes to drill a hole, etc. in the siding to connect electrical lines, telephone wires and various other products and objects. For example, one wishing to drill a hole in the vinyl siding, may discover the brittleness causes cracks to form rather than a clean drill hole. This results in the vinyl siding having to be replaced and/or repaired thus drastically increasing the repair cost and repair time.

Various methods have been utilized in order to overcome these disadvantages; such as when cutting a piece of siding or other material, the carpenter may leave the siding inside a house or structure and cut the material indoors. In this instance, the material remains flexible when being cut and is not exposed to the cold until placed in position outdoors. Unfortunately, access to an indoor heated space is not always available to the carpenter working out in the environment.

Another solution has utilized large gas heaters and blowers. The construction crew or worker purchases a large air blower and relocates the blower from job site to job site. The blower dissipates a large amount of heat in a given area, reducing the cold weather affects on the material being worked on such as vinyl siding. Unfortunately, some of the disadvantages associated with this technique include a large up-front cost for purchasing large-scale heaters; the inconvenience of relocating heavy machinery from job site to job site; may require a tarp to enclose the heat and the additional fuel cost for running the heater or blower.

### SUMMARY OF THE INVENTION

The present invention relates to a combination tool assembly for working on a material. The assembly includes a hand tool portion having a working end for engaging the material. The assembly also includes a forced air portion having a blower and an outlet. The blower and outlet are in communication with each other. Further, the outlet is positioned on the hand tool portion and aimed toward the working end so that upon actuation of the forced air portion, the outlet projects an air stream toward the material.

The tool assembly may also include a heating element in communication with the blower. The hand tool portion may be manually actuatable.

In a preferred embodiment, the outlet is oriented at such a position to direct the air stream in front of an engagement point between the material and the hand tool portion. The hand tool portion and the forced air portion may be integral.

The tool assembly may further include at least one actuating switch and a power source. The power source may consist of a battery, a flammable material, an electric connection adapted for connecting to an external power source or the like.

In a preferred embodiment of the present invention the tool assembly may further include a fastener having a first curve wall defining a first aperture and a second curve wall defining a second aperture as well as a locking element pivotally connecting the first curve wall to the second curve wall. The first aperture is adapted for receiving a forced air portion and a second aperture is adapted for receiving at least part of the hand tool portion. As the locking element is tightened the forced air portion and the hand tool portion are locked within the first and second apertures respectively.

In a preferred embodiment the hand tool portion may be a pair of shears having a first and second blade part and a first and second handle part. The first blade part is coupled to the first grip part to form a first bar while the second blade part is coupled to the second grip part to form a second bar. The first and second bars are pivotally attached. The forced air portion is coupled to the handle by a fastener. The fastener including a curve wall partially defining an aperture, a clamping element and a locking element. The forced air portion is received by the aperture and a clamping element engages the handle of the hand tool portion. The locking element has a substantially cylindrical portion and is adapted for tightening the first aperture about the forced air portion and tightening the clamping element about the handle.

The combination tool assembly may further include a fastener having a first curve wall defining an aperture adapted for receiving the forced air portion and an extending portion coupled to the first curved wall wherein the hand tool portion includes a surface mounting portion adapted for engaging the extending portion.

The hand tool portion may be a saw.

The present invention also includes a method of working on a material including blowing air against the material while engaging the material with a manually actuated tool. The air may be warm relative to the temperature of the material. Further, the air may impinge the material in front of an engagement point between the tool and the material.

### BRIEF DESCRIPTION OF THE DRAWINGS

FIG. 1 is a side view of a first embodiment of the present invention;

FIG. 2 is a perspective view of a fastener used in the embodiment of FIG. 1;

FIG. 3 is a side view of a second embodiment of the present invention;

FIG. 4 is a perspective view of a fastener used in the embodiment of FIG. 3;

FIG. 5 is a side view of a third embodiment of the present invention;

FIG. 6 is a perspective view of a faster used in the embodiment of FIG. 5;

FIG. 7 is a side view of a fourth embodiment of the present invention;

FIG. 8 is a perspective view of a fastener used in the embodiment of FIG. 7; and;

FIG. 9 is a side view of an alternate embodiment of the present invention.

### DETAILED DESCRIPTION

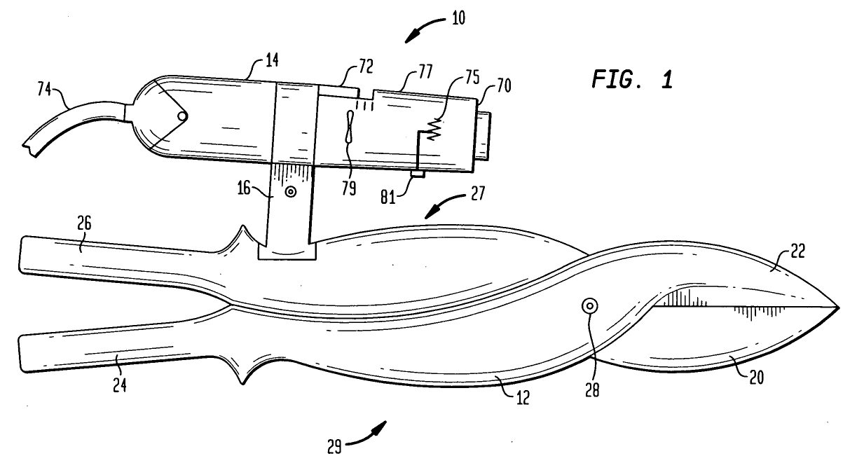

FIG. 1 shows one embodiment of the present invention and includes combination tool assembly 10. Tool assembly 10 includes shears 12 and forced air portion 14 coupled together by fastener 16. Shears 12 may be any ordinary known conventional pair of shears. Preferably, shears 12 include two cutting blades 20 and 22 and actuating grip handles 24 and 26. Each cutting blade is rigidly connected to a grip handle to form elongate bars 27 and 29, which are preferably pivotally connected. Pivoting structure 28 enables bars 27 and 29 to be pivoted relative to each other about a pivoting axis.

Forced air portion 14, preferably includes a housing 77, a blower 79, and an outlet 70. Blower 79 allows forced air portion 14 to expel an air stream outwardly from outlet 70. More preferably forced air portion 14 includes a heating element 75 for increasing the temperature of air projected from blower 79 prior to the air exiting outlet 70. A controller 81 may communicate with heating element 75 to allow adjusting of the temperature of the heating element. Additionally the forced air portion 14 may also include an actuation switch 72 and a power connection 74 for attaching to a power supply. Forced air portion 14 may consist of a conventional appliance for delivering a stream of warm air. One that can be used is a conventional hair dryer.

Preferably, forced air portion 14 is releasably attached to shears 12 using various techniques including but not limited to the two elements being taped, strapped, clipped, or tied to one another. Realistically, any method of coupling to parts together may be used. In some embodiments, shears 12 may be coupled to forced air portion 14 using an intermediate body, such as fastener 16.

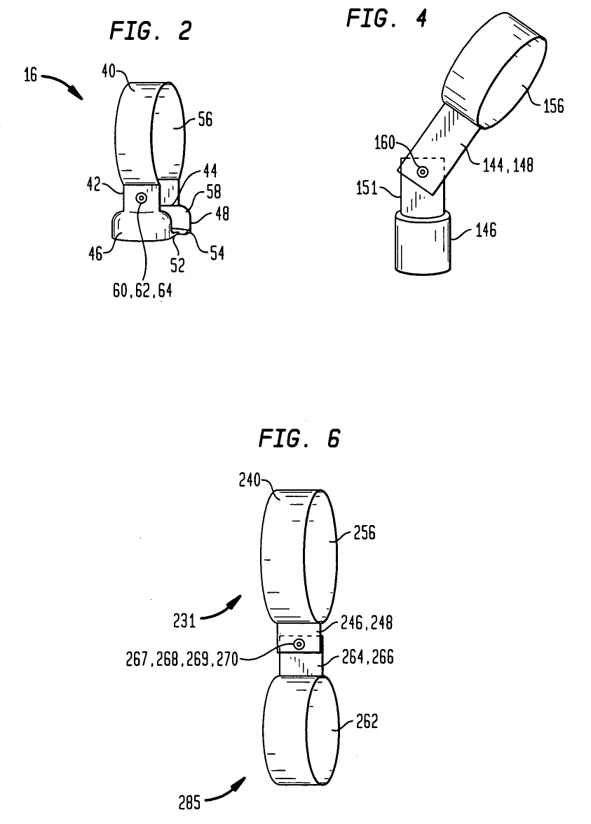

As shown in FIG. 2, fastener 16 may include curved wall 40. In a preferred embodiment, curved wall 40 is substantially cylindrical as shown in the figure. Curved wall 40 has two remote ends 42 and 44. Extending down from the two remote ends 42 and 44 are extensions 46 and 48, each preferably having at least one aperture 62 and 64. Inwardly facing flanges 50 and 52 extend from a bottom portion of extensions 46 and 48 respectively and are substantially perpendicular to the extensions. Flanges 52 and 54 are remote from one another and include a spacing therebetween. Additionally, fastener 16 includes an upper first aperture 56 and a lower second aperture 58. Although the apertures 56 and 58 may communicate with one another, their designation as upper and lower have been included for purposes of positioning. Fastener 16 may also include locking element 60 for cooperating with apertures 62 and 64. The functions of locking element 60 will be described below.

With reference back to FIG. 1, fastener 16 is shown engaging handle 26 of shears 12. In one method of assembling the device, prior to fastener 16 engaging handle 26, forced air portion 14 may be received within upper aperture 56. Extensions 46 and 48 and flanges 52 and 54 are then positioned about handle 26, with handle 26 being disposed within aperture 58. Locking element 60 may already be placed within or alternatively be received by side apertures 62 and 64 disposed within extensions 46 and 48, respectively. Locking element 60 may include various elements such as bolts, nuts, screws, and the like. After being maneuvered through apertures 62 and 64, locking element 60 may be tightened to subsequently cause the distance between extensions 46 and 48 to be reduced as well as the size of aperture 56. This results in extensions 52 and 54 tightening about handle 56 and curved wall 40 tightening around forced air portion 14. The locking element may be further tightened until the forced air portion 14 and shears 12 are locked relative to one another. In a preferred embodiment, fastening element 16 engages shears 12 as close to pivoting structure 28 as possible to reduce movement of forced air portion 14 as grip handles 24 and 26 are opened and closed.

In a preferred embodiment, the fastener 16 along with locking element 60 permit pivoting of forced air portion 14 relative to shears 12 so that outlet 70 of the forced air portion may be oriented in a desired direction to outwardly projects a stream of air. In a most preferred embodiment, forced air portion 14 is positioned so that the air stream emanating from outlet 70 infringes the material slightly in front of the engagement point between shears 12 and the material.

In an alternate embodiment, connector 74 may be replaced or supplemented with a battery, a combustible or flammable material such as butane and propane cylinders. As with any of the power supplies, their purpose is to provide energy for creating an outwardly projecting air stream as well as possibly causing heating element 75 disposed within housing 77 of forced air portion 14 to dissipate heat in order to increase the temperature of the projecting air stream. In a preferred embodiment a flammable material may be used to power the heating element and a battery may be used to power the blower. Of course, the size, type, and capacity of the power supply may vary depending on the power required by the specific embodiment. An example of a power output that may be used with the present invention includes an 1000 watt conventional hair dryer.

Although a preferred embodiment of forced air portion 14 is shown in FIG. 1, as being cylindrical, it will be realized by those skilled in the art that forced air portion 14 may have various configurations such as square, rectangular, triangular or the like and even non-geometrical. However, if the shape of forced air portion 14 were to be modified, fastener 16, specifically, upper aperture 56, may also be modified to be engageable and coupled to the forced air portion 14.

The orientation of the forced air portion 14 relative to the shears 12, permits a carpenter to project a stream of air, preferably warm, at the material he or she is cutting. The stream of air will preferably project enough heat against the material to reduce effects caused by exposure of the material to a cold environment such as becoming brittle. This results in the reduction of unwanted cracking and tearing along the material being cut. In alternate embodiments, forced air portion 14 may be modified to project a cool stream or air if one so desires.

As shown in FIG. 3, the present invention may be adapted for saws such as power saw 112 of combination tool assembly 110. Forced air portion 114 may be substantially similar to forced air portion 14 in that it may include many of the same elements and options available to forced air portion 14. Forced air portion 114 is connected to saw 102 using fastener 116.

Fastener 116 has an upper portion similar to fastener 16, and may include curved wall 140 and first aperture 156. As shown in FIG. 4, curved wall 140 may also have extension 146 and 148 projecting from remote ends of curved wall 140. In a preferred embodiment, a radially extending cylindrical tube 149 is pivotally connected to extensions 146 and 148 via extension 151. Tube 149 is capable of receiving or screwing onto a mounting surface 153 (shown in hidden view) located on power saw 112. The mounting surface 153 may be positioned anywhere along power saw 112; however, in a preferred embodiment, mounting surface 153 is disposed on power saw 112 so that outlet 170 of forced air portion 114 and more importantly, a projecting air stream emanating from outlet 170 may be directed onto a material being worked on at a desired location.

Consistent with fastener 16, fastener 116 may include a locking element 160, which when tightened causes curved wall 140 to lock forced air portion 114 within aperture 156. In a preferred embodiment locking element 160, permits pivoting of curved wall 140 relative to extension 151.

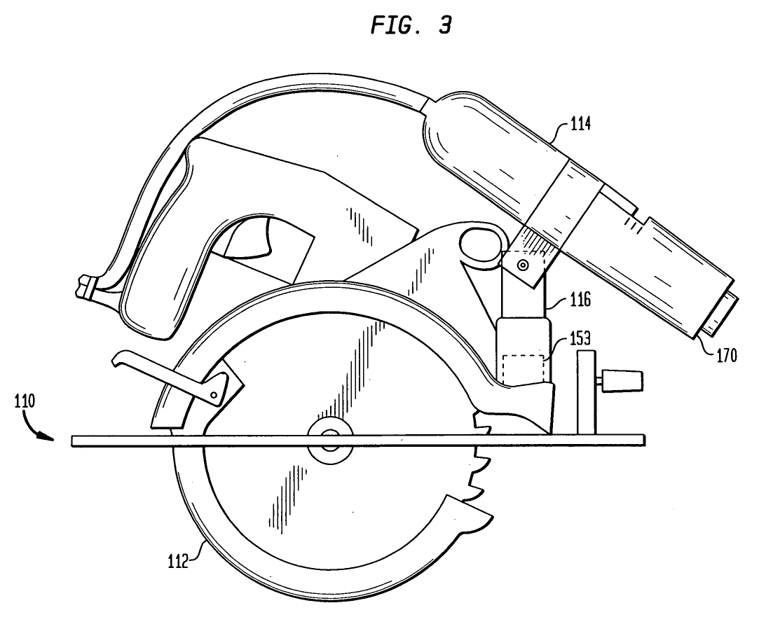

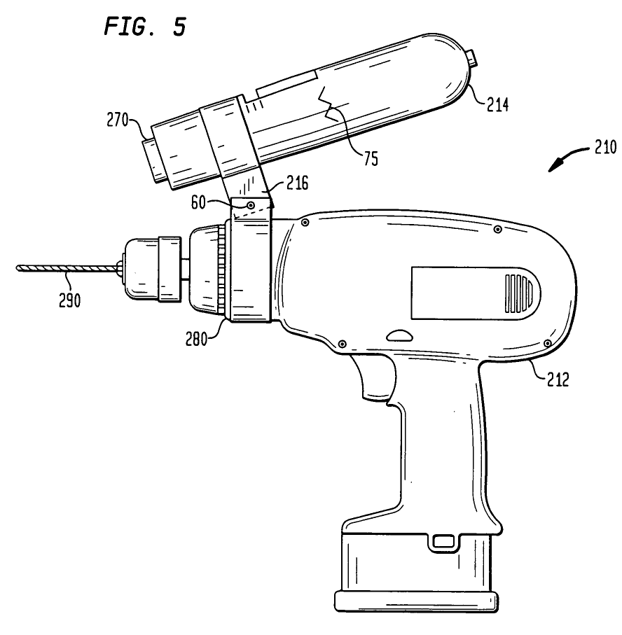

A third embodiment of the present invention is shown in FIGS. 5 and 6, illustrating combination tool assembly 210. Tool assembly 210 includes drill 212 coupled to forced air portion 214. Fastener 216 connects the two elements and again preferably has an upper portion similar to fastener 16. Specifically, fastener 216 includes a curved wall 240 defining upper aperture 256 and two extensions 246 and 248 extending downward from remote ends of curved wall 240. Fastener 216 may have a lower half similar to its upper half and include a second curved wall 260 defining lower aperture 262. Two extensions 264 and 266 extend upward from remote ends of curved wall 260. All four extensions 246, 248, 264 and 266 preferably include apertures 267, 268, 269 and 271, respectively, extending therethrough which, when aligned, share a common central axis. In one method of assembling forced air portion 214 and drill 212 together, upper portion 231 and lower portion 233 may be disengaged from one another. Lower portion 233 is then positioned about front cylindrical housing 280 of drill 212 with the cylindrical housing being received within lower aperture 262.

Similarly, upper portion 231 receives forced air portion 214 within upper aperture 256. Apertures 267 and 268 of upper portion 231 and apertures 269 and 271 of lower portion 233 are aligned with one another so as to share a common central axis. Locking element 260 is then received within the four apertures. As previously described, the locking element 260 may be tightened in order to lock the four extensions relative to one another. Tightening locking element 260 has the desired effect of reducing the size of upper aperture 256 as well as lower aperture 262. The fastener is tightened until both apertures lock the drill 212 and forced air portion 214 relative to one another. Preferably, prior to locking the assembly, forced air portion 214 is oriented in correct position so that outlet 270 projects an air stream at the desired location. Thus, when using the drill assembly, as drill bit 290 engages material, the forced air portion 214 may deliver a stream of air at the contact point between drill bit 290 and a given material. This results in the stream of air modifying the temperature of the material to reduce cold weather effects.

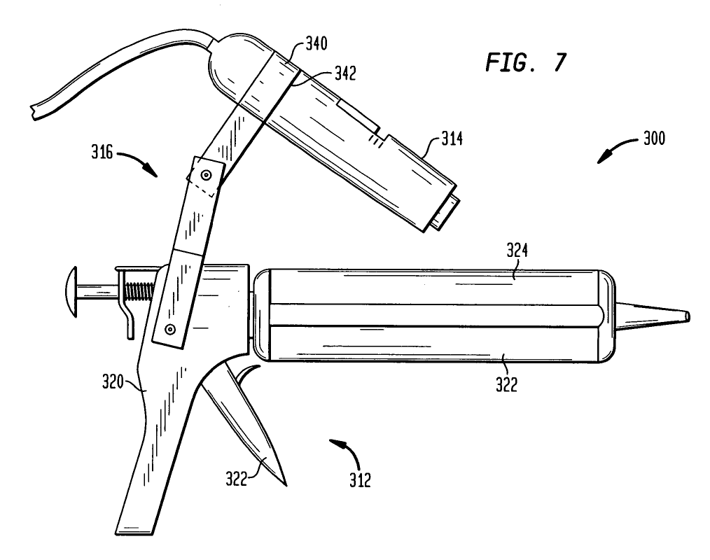

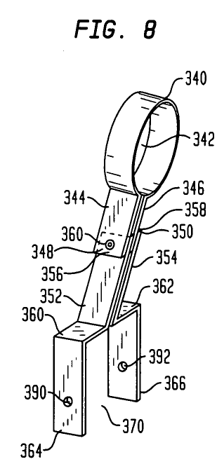

In an alternate embodiment of the present invention, as shown in FIG. 7, combination tool assembly 300 may include a caulking gun 312 coupled to forced air portion 314. Caulking gun 312 may be any ordinary caulking gun known in the art and preferably includes a handle 320 with an actuation grip 322. Extending radially outward from handle 320 is cylinder 322 which includes an opening 324 for receiving a tube of caulk or the like.

Forced air portion 314 may be similarly designed as previous forced air portions described herein and may be coupled to caulking gun 312 via techniques described herein including, but not limited to, taped, strapped, interlocked and also by fastener 316. Fastener 316 (FIG. 8) may be substantially similar to fastener 16 shown in FIG. 2 including having a curved wall 340 at least partially defining aperture 342 for receiving forced air portion 314. Fastener 316 also may include two extensions 344 and 346 extending downward from remote ends of curved wall 340. Extensions 344 and 346 preferably also include apertures 348 and 350 extending through extensions 344 and 346, respectively. Apertures 348 and 350 are preferably concentric circles sharing a common longitudinal axis. Fastener 316 further includes lower extensions 352 and 354 also having apertures 356 and 358 extending therethrough, respectively, Apertures 356 and 358 are also preferably concentric circles having a common longitudinal axis extending therethrough. Adjacent to lower extensions 352 and 354 are outwardly extending flanges 360 and 362 which are designed to abut a portion of handle 320. Extending downward from the ends of flanges 360 and 362 are projections 364 and 366. Projections 364 and 366, as well as flanges 360 and 362, at least partially define opening 370 designed for receiving or straddling handle 320.

As with previous fasteners, fastener 316 may include a locking element 360 received within apertures 348, 350, 356 and 358 of their respective extensions. Upon tightening of the locking element, the spacing between each set of extensions and projections is reduced, thus causing curved wall 340 to tighten about forced air portion 314 disposed within aperture 340. Additionally, the distance between projections 364 and 366 is reduced in order that the projections as well as flanges 360 and 362 may clamp down on handle portion 320.

Additional bores 390 and 392 may be disposed along projections 364 and 366 and be able to be aligned with a bore located on handle 320 (not shown in the figures). These three holes may be aligned and then receive a second locking element to further lock fastener 316 to caulking gun 312.

Another embodiment, not shown in the figures includes a forced air portion being coupled to a hand held tape dispenser. This arrangement minimizes the difficulty of applying tape to various boxes and containers in cold climate conditions. Such that upon exposure to the cold, the tape itself becomes brittle and loses its adhesive properties. The forced air portion can be positioned to supply a warm air current against the tape thereby reducing the negative effects of the cold.

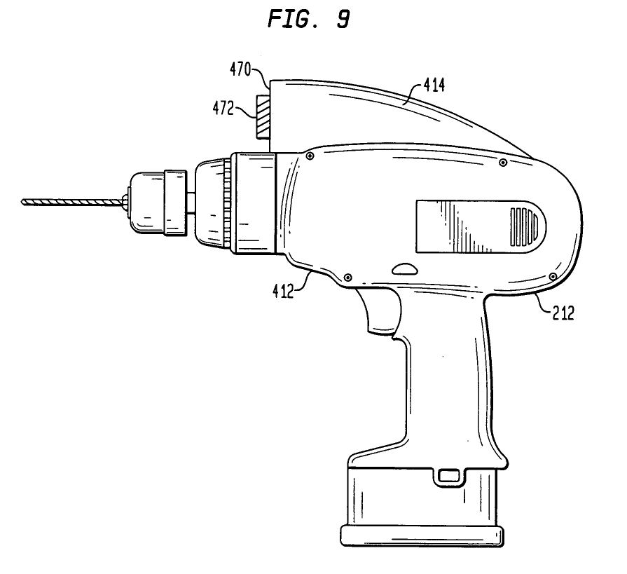

In an alternate embodiment, the forced air portion and the hand tool element may be integrally formed. Thus, as shown in FIG. 9, forced air portion 414 is shown integral with drill 412. Outlet 470 of forced air portion 414 may also include a guiding mechanism such as a vent which allows a person to direct the flow of the air stream projecting from the outlet 470. Although the present embodiment has been shown utilizing the combination of a forced air portion with a drill, the present embodiment is not limited to this. Specifically, forced air portion may be integrally formed with any of the tools herein described as well as additional tools not disclosed in the reference. Furthermore, as earlier discussed, the forced air portions described herein may include their own power pack for supplying enough power to the forced air portion to enable the forced air portion to project an air stream outward as well as possibly heating the air stream and adjusting the temperature of the air.

In an alternate embodiment, not shown in the figures, the forced air portion may include a hose or conduit associated with a hand tool portion. The hose may have an outlet similar to outlet 70 for projecting an air stream and positioned on a hand tool portion to project air against the material engaged by the hand tool portion. The hose may have a second end remote from the outlet and associated with a blower. The blower is preferably remote from the hand tool position and may be positioned on the ground or a floor in a truck or elsewhere. The blower may also include a heating element. Upon discovering that the weather is negatively impacting the work environment, the carpenter may connect the hose with an associated blower to a hand tool to overcome the negative effects of the cold.

In a most preferred embodiment, each embodiment has a forced air portion releasably attached to a hand tool portion. This enables the present invention to be assembled when required as well as enables the forced air portion, when not required to be removed from the hand tool portion. Thus, any common hand tool may be coupled to the forced air portion without accruing additional expenses. Additional methods of attaching a hand tool to a forced air portion include a key and key way assembly, a slot and tab assembly as well as various other structures.

The present invention may also be adapted for one or more power supplies. Namely, the hand tool portion and the forced air portion may either have separate and distinct power packs or share a common power pack for supplying them with energy.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims. One such example is the inclusion of varying fasteners. The fasteners described herein are an illustration on how one may prefer to couple the two portions of the invention; however, it should be realized that many other fastener embodiments may be used without deviating from the scope of the present invention.

1. A combination tool assembly for working on a material, the assembly comprising:
a hand tool portion having a working end for engaging the material;
a forced air portion having a blower and an outlet, said blower and said outlet in communication with each other, wherein said outlet is positioned on said hand tool portion and aimed toward said working end so that upon actuation said forced air outlet projects an air stream toward the material.

2. The combination tool assembly according to claim 1, wherein said forced air portion includes a heating element in communication with said blower.

3. The combination tool assembly according to claim 1, wherein said hand tool portion is manually actuatable.

4. The combination tool assembly according to claim 1, wherein said outlet is oriented at such a position to direct the air stream in front of an engagement point between the material and said hand tool portion.

5. The combination tool assembly according to claim 1, wherein said hand tool portion and said forced air portion are integral.

6. The combination tool assembly according to claim 1 comprising at least one actuating switch and a power source.

7. The combination tool assembly according to claim 6, wherein said power source includes a battery.

8. The combination tool assembly according to claim 6, wherein said power source includes a flammable material.

9. The combination tool assembly according to claim 6, wherein said power source includes an electric connection adapted for connecting to an external power source.

10. The combination tool assembly according to claim 1 comprising:
a fastener, said fastener including a first curved wall defining a first aperture and a second curved wall defining a second aperture and a locking element pivotally connecting said first curved wall to said second curved wall, wherein said first aperture is adapted for receiving said forced air portion and said second aperture is adapted for receiving at least a part of said hand tool portion, wherein said locking element is adapted to be tightened and lock said first forced air portion and said hand tool portion within said first and second apertures respectively.

11. The combination tool assembly according to claim 1, wherein said hand tool portion is a pair of shears, said shears having a first and second blade part and a first and second grip part, said first blade part coupled to said first grip part to form a first bar, said second blade part coupled to said second grip part to form a second bar, wherein said first and second bar are pivotable attached, wherein said forced air portion is coupled to said handle by a fastener, said fastener including a curved wall at least partially defining an aperture, a clamping element and a locking element, wherein said forced air portion is received by said aperture, and said clamping element engages said handle of said hand tool portion, wherein said locking element has a substantially cylindrical portion and is adapted for tightening said first aperture about said force air portion and tightening said clamping element about said handle.

12. A combination tool assembly according to claim 1 comprising:
a fastener, said fastener including a first curved wall defining an aperture adapted for receiving said forced air portion and an extending portion coupled to said first curved wall, wherein said hand tool portion includes a surface mounting portion adapted for engaging said extending portion.

13. The combination tool assembly according to claim 12, wherein said hand tool portion is a power saw.

14. A combination tool assembly for working on a material, the assembly comprising:
a pair of shears having a first and second blade part and a first and second handle part;
a forced air portion having an outlet adapted for projecting a stream of air and a power supply; and
a fastener adapted for coupling said pair of shears to said forced air portion.

15. The combination tool assembly according to claim 14, wherein said fastener includes a curved wall at least partially defining an aperture, said aperture adapted for receiving said forced air portion, said fastener having a clamping portion for locking said pair of shears relative to said fastener.

16. A method of working on a material comprising:
blowing air against the material while engaging the material with a manually actuated tool.

17. The method of claim 16, wherein said air is warm relative to a temperature of the material.

18. The method of claim 15, wherein said air impinges the material in front of an engagement point between said tool and the material.
